(19) United States
(12) Patent Application Publication
(10) Pub. No.: US 2007/0212529 A1
(43) Pub. Date: Sep. 13, 2007

(54) Printed circuit board having metal core

(75) Inventors: Seung-Hyun Cho, Seoul (KR); Sang-Jin Oh, Suwon-si (KR); Young-Goo Kim, Saha-gu (KR); Kwang-Yune Kim, Suseong-gu (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 11/715,905

(22) Filed: Mar. 9, 2007

(30) Foreign Application Priority Data
Mar. 10, 2006 (KR) 10-2006-0022564

(51) Int. Cl. B32B 3/00

(52) U.S. Cl. 428/209; 428/901

(57) ABSTRACT

A printed circuit board having a metal core is disclosed. A printed circuit board that includes a metal core and an insulation layer stacked on at least one surface of the metal core, where a portion of the insulation layer is removed to expose an edge surface of the metal core to the exterior and thereby form an exposed surface, allows superb heat release through the exposed surface.

### CROSS-REFERENCE TO RELATED APPLICATIONS

This application claims the benefit of Korean Patent Application No. 10-2006-0022564 filed with the Korean Intellectual Property Office on Mar. 10, 2006, the disclosure of which is incorporated herein by reference in its entirety.

### BACKGROUND

1. Technical Field

The present invention relates to a printed circuit board having a metal core.

2. Description of the Related Art

As electronic products are being made smaller and lighter, represented by the trends of smaller, thinner, higher-density, packaged, and portable products, so also is the multilayer printed circuit board undergoing a trend towards finer patterns and smaller and packaged products. Accordingly, along with changes in the raw materials for forming fine patterns on the multilayer printed circuit board and for improving reliability and design density, there is a change towards integrating the layer composition of circuits. Components are also undergoing a change from DIP (dual in-line package) types to SMT (surface mount technology) types, so that the mounting density is also being increased. Further, the development of portable electronic devices, as well as demands for more functionalities, Internet use, video clips, and high-capacity data transmission, etc., create a need for more complicated designs and higher levels of technology for the printed circuit board.

As such, methods have been conceived for embedding a metal core in a printed circuit board, where in such a printed circuit board, an insulation layer is formed on the surface of a metallic substrate, such as of aluminum, etc., which has a heat-releasing effect, after which a conductive circuit pattern is formed by a print wiring process. Then, a plurality of electric components such as power parts and control parts that require heat release are mounted in a high density on the circuit pattern. The heat release in a printed circuit board having electric components mounted in a high density is, achieved by a method of heat transfer which is based on convection or radiation, etc., or which utilizes fins, etc.

However, heat release relying on convection or radiation is made low in efficiency, because the convection heat transfer coefficient and radiation heat transfer coefficient are low, while the method of using fins or fans not only increases the volume but also additionally incurs high power consumption.

### SUMMARY

An aspect of the invention is to provide a printed circuit board having a metal core, which allows superb heat release.

A printed circuit board according to one aspect of the invention includes a metal core and an insulation layer stacked on at least one surface of the metal core, where a portion of the insulation layer is removed to expose an edge surface of the metal core to the exterior, thereby forming an exposed surface.

The printed circuit board having a metal core, according to certain embodiments of the invention, may have one or more of the following features. For example, the insulation layer may include an upper insulation layer stacked on the upper surface of the metal core and a lower insulation layer stacked on the lower surface of the metal core, where the upper insulation layer may have an electric component mounted thereon, and the lower insulation layer may have a portion removed to form the exposed surface. The metal core may be made of any one of aluminum, copper, and stainless steel, or an alloy thereof. The metal core may have a quadrilateral shape, with portions of the insulation layer removed on two parallel sides in correspondence with the shape of the metal core. The metal core may have a quadrilateral shape, with portions of the insulation layer removed on four sides in correspondence with the shape of the metal core.

The insulation layer may include an upper insulation layer stacked on the upper surface of the metal core and a lower insulation layer stacked on the lower surface of the metal core, where the upper insulation layer may have an electric component mounted thereon, and the upper insulation layer and the lower insulation layer may have portions removed to form the exposed surface. The metal core may be made of aluminum, with a black alumite layer formed on the exposed surface.

Additional aspects and advantages of the present invention will become apparent and more readily appreciated from the following description, including the appended drawings and claims, or may be learned by practice of the invention.

### BRIEF DESCRIPTION OF THE DRAWINGS

FIG. 1 is a perspective view of a printed circuit board having a metal core according to an embodiment of the invention.

FIG. 2 is a cross-sectional view of the printed circuit board of FIG. 1 across line I-I′.

FIG. 3 is a schematic diagram illustrating a printed circuit board having a metal core according to an embodiment of the invention secured to a case.

FIG. 4 is a schematic diagram illustrating portion “A” which shows how the printed circuit board having a metal core according to an embodiment of the invention shown in FIG. 3 is joined with the case.

FIG. 5 is a perspective view of a printed circuit board having a metal core according to another embodiment of the invention.

FIG. 6 a cross-sectional view of the printed circuit board of FIG. 5 across line II-II′.

### DETAILED DESCRIPTION

Embodiments of the invention will be described below in more detail with reference to the accompanying drawings, in which those components are rendered the same reference number that are the same or are in correspondence, regardless of the figure number, and redundant explanations are omitted.

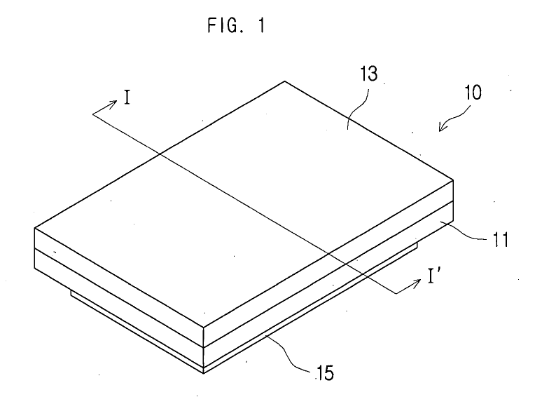

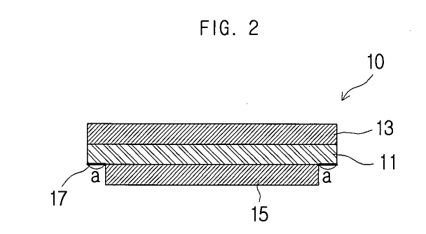

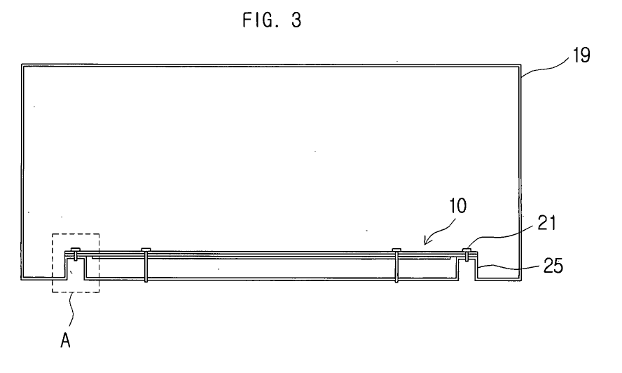

Referring to FIGS. 1 and 2, a printed circuit board having a metal core according to an embodiment of the invention includes a metal core 11 and an upper insulation layer 13 and lower insulation layer 15 stacked on either side of the metal core 11. Although it is not depicted in the drawing, active components such as IC's, as well as passive components such as capacitors, may be mounted on the upper insulation layer 13, while portions of the lower insulation layer 15 are removed such that an exposed surface 17, which corresponds to the edge surface of the metal core 11, is exposed to the exterior. The exposed surface 17 is put in direct contact with the case 19 (see FIG. 3) and secured, and since it is in direct contact with exterior air, there is superb heat release through the exposed surface 17.

The metal core 11 is interposed between the upper insulation layer 13 and lower insulation layer 15, and releases heat generated by the electric component (not shown) mounted on the upper insulation layer 13 to the exterior. Also, as the metal core 1I has a strength greater than that of the insulation layer, which is formed of epoxy resin, etc., it provides greater resistance to warpage. The metal core 11 is made of aluminum, copper, stainless steel, or an alloy thereof, all of which have superb heat conduction properties. While the metal core 11 may generally have a quadrilateral shape, it is not thus limited, and the shape may vary depending on the form of the case to which the printed circuit board 10 will be joined.

The lower insulation layer 15 is formed on the lower surface of the metal core 11, and the exposed surface 17 is formed on the edge surface where portions of the lower insulation layer 15 are removed. The exposed surface 17, when the printed circuit board 10 is subsequently secured to a case, etc., is exposed to the exterior, to allow easier heat release by convection and radiation. When the metal core 11 has a quadrilateral shape, the exposed surface 17 may be formed such that a pair of edge surfaces parallel to each other are exposed. Also, the exposed surface 17 may be formed, as illustrated in FIG. 1, such that two pairs of edge surfaces respectively parallel to each other are exposed.

When the metal core 11 is made of aluminum, a black alumite layer may be formed on the exposed surface 17. The black alumite layer has an emissivity of ε=0.8, which is very high compared to the emissivity ε=0.3 of white alumite. Thus, by forming the black alumite layer on the exposed surface 17, heat release by radiation is made easier. The black alumite layer may be formed by a method such as silk printing or laser marking, etc.

The upper insulation layer 13 and lower insulation layer 15 are each stacked on either side of the metal core 11. The upper insulation layer 13 and lower insulation layer 15 may be made of a material generally used, such as epoxy resin, glass epoxy resin, and epoxy resin containing alumina, etc., but is not thus limited. It is apparent that the thicknesses of the upper insulation layer 13 and lower insulation layer 15 may vary as necessary.

Passive components, as well as active components, etc., may be mounted on the upper insulation layer 13, where such electric components may be stacked directly on a surface of the upper insulation layer 13 or alternatively may be mounted after stacking another insulation layer (not shown) on. Most of the heat generated in an electric component mounted on the upper insulation layer 13 or on another insulation layer formed thereon is conducted through the upper insulation layer 13 to the bottom surface of the metal core 11. Afterwards, the conducted heat is released to the exterior by means of convention or radiation, and since the exposed surface 17 is exposed to the exterior, most of the heat is released through the exposed surface 17 to the exterior.

As illustrated in FIG. 2, the lower insulation layer 15 has portions of its edges removed, whereby the exposed surface 17 of the metal core 11 is formed. Methods of forming the exposed surface 17 may include typical etching processes, etc., but are not thus limited. The width a of the exposed surface 17 may vary depending on the size of the securing member 25 of the case 19 (see FIG. 3) to which the printed circuit board 10 is joined.

As the exposed surface 17 is exposed to the exterior, the heat transferred to the metal core 11 is readily released to the exterior. As described above, a black alumite layer may be formed on the exposed surface 17 to further increase the emissivity. Heat may be released through the exposed surface 17 to the exterior by means of convection and radiation, or by means of heat conduction through direct or indirect contact with the securing member 25 of the case 19.

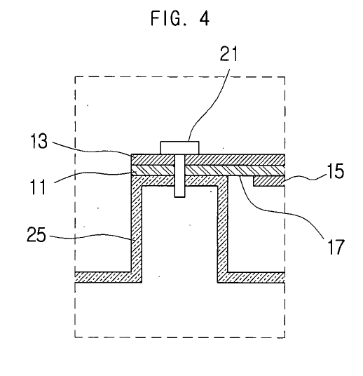

Referring to FIGS. 3 and 4, a printed circuit board 10 based on an embodiment of the invention is secured to a case 19, etc. The case 19 is made of metal and has securing members 25 for securing the printed circuit board 10, where each corner of the quadrilateral printed circuit board 10 is secured by a screw 21, etc., to the securing member 25. The exposed surface 17 of the printed circuit board 10 is in direct or indirect contact with a surface of the securing member 25, so that the heat of the metal core 11 is released by heat conduction through the securing member 25 to the case 19. Since the case 19 has a large external area, it is able to efficiently release heat. In particular, when the case 19 is made of metal, for instance the same material as that of the metal core, such as aluminum, etc., the entire case 19 may be used as a heat-release plate, to provide superb heat releasing. Also, at the portions of the exposed surface 17 that are not in contact with the securing member 25, heat may be released to the exterior by means of convection and radiation.

While screws 21 are shown as the means for joining the printed circuit board to the securing members 25 in this embodiment, the invention is not thus limited, and it is apparent that other means may be used, such as heat resistant tape, for uniform contact.

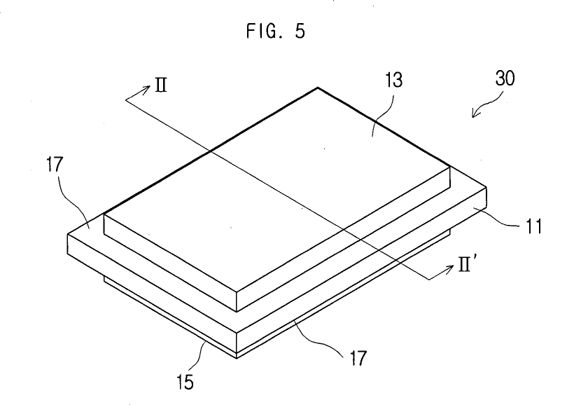

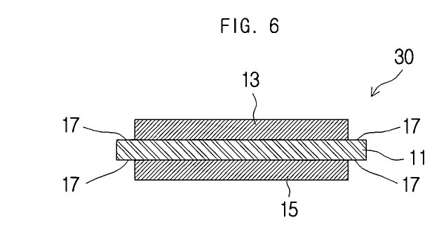

A printed circuit board 30 based on another embodiment of the invention will be described below with reference to FIGS. 5 and 6.

Referring to FIGS. 5 and 6, the composition of the printed circuit board 30 based on another embodiment of the invention is very similar to that of the printed circuit board 10 based on the embodiment set forth above. However, there is a difference in that the printed circuit board 30 based on this embodiment has an exposed surface 17 formed on also on the side of the upper insulation layer 13. The method of forming the exposed surface 17 on the side of the upper insulation layer 13 is the same as the method described above for forming the exposed surface 17 on the side of the lower insulation layer 15. The width of the exposed surface 17 may also be selected in consideration of the size of the printed circuit board 30 and the type and heat emission of the electric component mounted.

The heat generated by the electric component may be released to the exterior through the exposed surface 17 on the side of the upper insulation layer 13 by means of convection or radiation. Also, when the securing members 25 of the case 19 (see FIG. 3 or 4) are in contact with both the upper and lower surfaces of the printed circuit board 30, heat may be released through the securing members 25 to the case 19 by means of heat conduction.

According to certain aspects of the invention as set forth above, a printed circuit board having a metal core may be provided that allows superb heat release.

While the present invention has been described with reference to particular embodiments, it is to be appreciated that various changes and modifications may be made by those skilled in the art without departing from the spirit and scope of the present invention, as defined by the appended claims and their equivalents.

What is claimed is:

1. A printed circuit board having a metal core, the printed circuit board comprising:
a metal core; and
an insulation layer stacked on at least one surface of the metal core,
wherein a portion of the insulation layer is removed to expose an edge surface of the metal core to the exterior, thereby forming an exposed surface.

2. The printed circuit board of claim 1, wherein the metal core is made of any one of aluminum, copper, and stainless steel, or an alloy thereof.

3. The printed circuit board of claim 2, wherein the metal core is made of aluminum,
and a black alumite layer is formed on the exposed surface.

4. The printed circuit board of claim 1, wherein the insulation layer comprises an upper insulation layer stacked on the upper surface of the metal core and a lower insulation layer stacked on the lower surface of the metal core,
the upper insulation layer having an electric component mounted thereon, and
the lower insulation layer having a portion removed to form the exposed surface.

5. The printed circuit board of claim 4, wherein the metal core is made of any one of aluminum, copper, and stainless steel, or an alloy thereof.

6. The printed circuit board of claim 5, wherein the metal core is made of aluminum,
and a black alumite layer is formed on the exposed surface.

7. The printed circuit board of claim 1, wherein the metal core has a quadrilateral shape,
and the insulation layer has portions removed on two parallel sides in correspondence with the shape of the metal core.

8. The printed circuit board of claim 7, wherein the metal core is made of aluminum,
and a black alumite layer is formed on the exposed surface.

9. The printed circuit board of claim 1, wherein the metal core has a quadrilateral shape,
and the insulation layer has portions removed on four sides in correspondence with the shape of the metal core.

10. The printed circuit board of claim 9, wherein the metal core is made of aluminum,
and a black alumite layer is formed on the exposed surface.

11. The printed circuit board of claim 1, wherein the insulation layer comprises an upper insulation layer stacked on the upper surface of the metal core and a lower insulation layer stacked on the lower surface of the metal core,
the upper insulation layer having an electric component mounted thereon, and
the upper insulation layer and the lower insulation layer having portions removed to form the exposed surface.

12. The printed circuit board of claim 11, wherein the metal core is made of aluminum,
and a black alumite layer is formed on the exposed surface.
